(19) United States
(12) Patent Application Publication
(10) Pub. No.: US 2015/0339692 A1
(43) Pub. Date: Nov. 26, 2015

(54) AUTOMATED VOLATILITY SCORE ADJUSTMENT OF ACCESS CHARGE CURVE FOR AUTOMATED DELIVERY OF NEWS ITEMS

(71) Applicant: Qbeats Inc., New York, NY (US)

(72) Inventor: Illan Poreh, Miami Beach, FL (US)

(73) Assignee: Qbeats Inc., New York, NY (US)

(21) Appl. No.: 14/719,276

(22) Filed: May 21, 2015

Related U.S. Application Data
(60) Provisional application No. 62/001,375, filed on May 21, 2014.

(51) Int. Cl. G06Q 30/02

(52) U.S. Cl. CPC G06Q 30/0206

(57) ABSTRACT

Methods, systems, and apparatus, including computer programs encoded on computer storage media, for receiving, using one or more processors at a system server, a plurality of articles and respective information for each respective article of the plurality of articles, where the respective information for the respective article; repeatedly receiving, at the system server, respective parameters associated with each article, where the respective parameters include at least a history of user access to articles other than the plurality of articles, where the respective parameters are updated over time; receiving, for each of the plurality of articles, user input identifying a new genre of the respective article; and repeatedly determining, for each article, an access price for the respective article over time, where each access price is based on the respective information, the respective parameters, and the new genre.

### RELATED CASES

This application claims benefit to U.S. Provisional Application 60/001,375, filed May 21, 2014, which is herein incorporated by reference in its entirety.

This application incorporates by reference the entire contents of the following patent applications:

(1) PCT application PCT/US12/39129 filed May 23, 2012;

(2) U.S. application Ser. No. 13/404,957 filed Feb. 24, 2012;

(3) PCT Application No. PCT/US13/54222 filed Aug. 8, 2013;

(4) PCT Application No. PCT/US13/54223 filed Aug. 8, 2013;

(5) PCT Application No. PCT/US13/54224 filed Aug. 8, 2013;

(6) PCT Application No. PCT/US13/54225 filed Aug. 8, 2013;

(7) PCT Application No. PCT/US13/54226 filed Aug. 8, 2013;

(8) PCT Application No. PCT/US13/54228 filed Aug. 8, 2013;

(9) PCT Application No. PCT/US13/54229 filed Aug. 8, 2013;

(10) PCT Application No. PCT/US13/54231 filed Aug. 8, 2013.

### BACKGROUND

In general terms, a content delivery system operates over communication links such as the Internet, and provides a convenient, automated way for publishers such as individual journalists to remotely access the system, enter and receive parameters that may affect the financial or other benefits from publishing an article, post an article together with parameters related thereto, and possibly engage in responding to questions from users or other publishers regarding the article or issues it raises and thus possibly generate additional financial or other benefits. Users at remote locations conveniently establish automated access to the system through which they can effectively identify articles of likely or at least possible interest, read or download them at access prices that dynamically track the actual worth of access based on user behavior and other factors, and possibly post questions related to the articles and receive answers.

### SUMMARY

The applications that are incorporated by reference describe various aspects of a system that provides a particularly effective and user-friendly way to find and read or download news articles and for publishers to publish articles accessible through the system.

The access price for a news item may typically follow a reasonably smooth S-curve, where the access price usually decreases with time and eventually approaches leveling off as the lifetime of the article approaches, before access becomes essentially or completely free. The changes in access price with time are designed to reflect user behavior, including for example the actual number of users that request access to a news item, together with other factors. However, it has been discovered that better overall results can be achieved if pricing also takes into account event that have a more volatile effect, and by triggering sharp departure up or down in the otherwise smooth S-curve in response to such events.

For example, a news item that started in its lifetime in the “opinion” genre may be recognized later as a more valuable “research” article during its lifetime. As one example, this recognition may result from the publisher of the article submitting a correction of the genre determination and the system automatically or through an administrator accepting the genre change. In this example, if a multiplier applied to a baseline price for the article in order to arrive at an access price was 0.9 for an opinion article but is 1.1 for a research article, the system responds by creating a sharp uptick in the S-curve to account for the genre change. Conversely, if the genre classification for the article changes from research to opinion, the result would be a sharp downtick in the access price. The genre classification is only one of many factors, with respective multipliers of a baseline price, that determine the access price, and changes in different ones of these factors may cause different upticks of downticks in the S-curve for the article.

This patent specification describes a new process that takes into account events that occur during the lifetime of an article and are sufficiently significant to be allowed to introduce volatility in the otherwise smooth S-curve of access price vs. time and thus enhance total revenue over a lifetime of an article or the achievement of some other overall goal of the system.

### BRIEF DESCRIPTION OF THE DRAWINGS

FIG. 1 is functional block diagram illustrating a general lifecycle of an article in the system.

FIG. 2 is illustrates the basic system of FIG. 1 but adds steps and equipment specific to accounting for volatile events causing excursions from a smooth S-curve of access price vs. time.

FIG. 3 illustrates an S-curve with excursions in response to volatile events.

Like reference numbers and designations in the various drawings indicate like elements.

### DETAILED DESCRIPTION

A unique aspect of the system is that it is provides users with articles at access fees that are much lower, typically of the order of Cents per access. These access prices tend to decrease dynamically with time and with access by more users because one of the goals can be to increase total revenue over a lifetime of the article. This is in contrast with prior systems that charge fixed fees in the tens of Dollars for access to an article from a professional journal, with little regard to the age of the article or the number of users, or a flat fee that is lower but does not change dynamically, or are designed to sell items from a finite supply, of apply charges that maximize profit for each sold item rather than overall revenue over a lifetime of an article the novelty and thus value of which can decrease dramatically with time. A unique aspect from a publisher's point of view is that a publisher can automatically receive immediate initial estimates regarding likely readership of the articles, initial valuation of financial benefits, lifetime of the article before access becomes essentially or completely free, and other parameters regarding the proposed article.

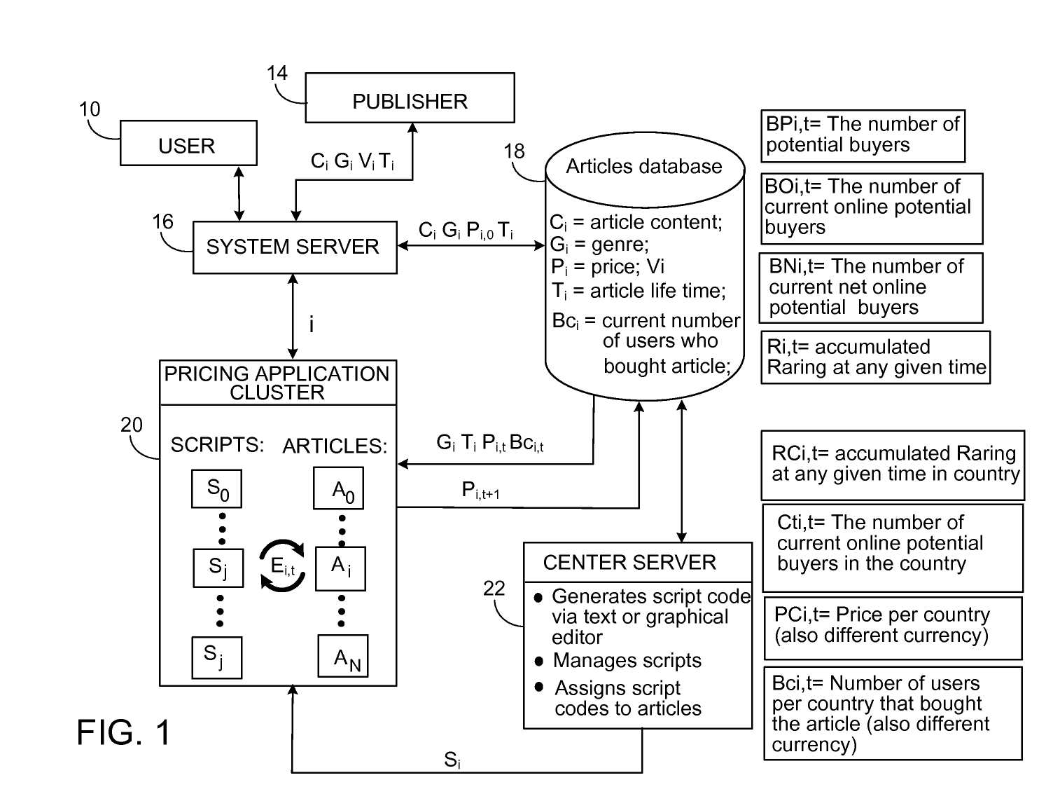

FIG. 1 illustrates in functional form the basic system described in the applications incorporated by reference. Consider the example of a publisher 14, for example a freelance journalist. The publisher is at a location remote from the system and uses a connection mechanism such as a personal computer, a tablet or some other device to establish a two-way electronic communication with a computer-implemented or computer-controlled system server 16, for example using a browser and the Internet. In response, system server 16 downloads to the publisher's device, over an electronic communication link, a screen display through which the publisher navigates and selects actions such as signing on the system, creating an account and/or a profile, changing settings, selecting or creating an active channel or accessing an inactive channel, submitting an article and information pertaining to the article, accessing other articles (and questions or comments thereon), uploading answers to questions posted by others, commenting on articles, etc., and signing out.

A typical input that a publisher provides when submitting an article identified by an index i (where i can be a unique number associated with the article) comprises the article content Ci, analysis information such as a genre designation Gi of the article and a synopsis of the article and keywords from or about the article, a value Vi that the publisher proposes for the article, and an initial lifetime Ti that the journalist proposes for the article. System server 16 receives this information and subjects it to initial automated, computer-implemented processing. For example, based on information stored in the system and on rules applied by the operation of computer programs in system server 16, the system server sets an initial price Pi,o for access to the article, and may change the genre designation Gi and the keywords associated with the article, and may change the value Vi and the initial lifetime Ti that the journalist proposed to a higher or lower value and/or a shorter or longer lifetime. This process may involve automated delivery to the publisher's screen of information about the likely interest of users and other publishers in the article and the likely revenue from access to the article, including information on likely current users who may be interested, likely future users, changes in the number and geographical distribution of likely accesses to the article, likely changes in pricing access to the article over time or in relation to other factors, etc., to thereby help publishers in the initial pricing and characterization of the article and in possible revisions therein, and with respect to possible future articles.

Basic operations of the equipment of with FIG. 1 and related figures in the patent applications incorporated by reference are not repeated in this patent specification because they are described in detail in the material incorporated by reference.

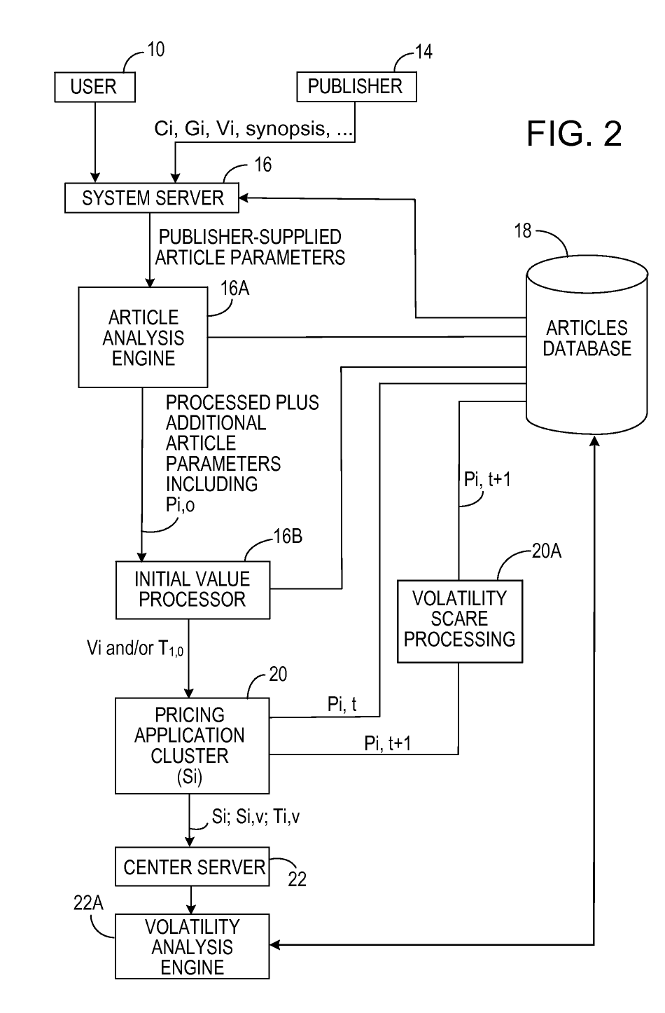

FIG. 2 shows an example system server that can be implemented as computer programs on one or more computers in one or more locations, in which the systems, components, and techniques described below are implemented.

Referring to FIG. 2, which adds to FIG. 1 certain elements that are specific to the process leading to sharp upticks or downticks in the access price for an article, a publisher 14 such as a journalist connects with system server 16 such as over the Internet using a common browser, transmits an offer of an article I and typically provides the article content Ci and parameters related to the article such as genre designation Gi, a publisher-proposed lifetime Ti for the article, and possibly a synopsis and keywords.

These can be provided through a user interface of the browser running on a client device. The client device can include a memory, e.g., a random access memory (RAM), for storing instructions and data and a processor for executing stored instructions. The memory can include both read only and writable memory. For example, the device can be a computer coupled to the system server through a data communication network, e.g., local area network (LAN) or wide area network (WAN), e.g., the Internet, or a combination of networks, any of which may include wireless links.

The device can be a smartphone, tablet, a desktop computer, or a laptop computer. The device is capable of receiving user input, e.g., through a touchscreen display or a pointing device, e.g., a mouse or a keyboard.

System server 16 includes or is associated with an article analysis engine 16a that subjects the article and its parameters to an analysis to confirm or modify the parameters that the publisher supplied and to typically generate additional parameters, with assistance of historical and other information from articles database 18, to thereby output a set of processed and possibly additional article parameters. The set of parameters includes an initial price Pi,o for access to the article, calculated as described in the material incorporated by reference. The additional parameters can include factors such as the genre or nature of the article (e.g., breaking news, opinion, research, etc.), whether the article includes visual material such as pictures, graphs, etc., the number of channels to which the article will be added, a uniqueness score related to how similar the article is to other articles, and possibly and indeed likely other parameters.

As described in the material incorporated by reference, pricing application clusters 20 applies a respective set of one or more scripts Si to the parameters for article i, which scripts are supplied from a center server 22 and can change from time to time, including during the lifetime Ti of the article. Pricing application cluster 20 makes access price Pi,t+1 available to users 10 through articles database 18 and system server 16 (or more directly). The process of supplying access price Pi,t+1 to articles database 18, then supplying current article parameters from article database 18 to pricing application cluster 20, where the current scripts Si are applied to generate a new access price after a time increment, is repeated throughout the lifetime Ti of the article. The initial price from cluster 20 to database 18 and back can be the initial price Pi,o. As a result, the access price varies over time in a manner that accounts for user behavior regarding the article and other material or events, and typically follows a smooth S-curve.

A volatility analysis engine 22a communicates with articles database 18 to determine a volatility score of the article essentially in real time. As a simple example at time T1!=To, i.e., during the lifetime of an article, a publisher 14 may request for a change in the genre classification of the article, for example a change of genre from “opinion” to “research.” A genre classification affect access price, for example based on multipliers for respective classifications applied to an initial baseline price for the article.

In some implementations, when changing a genre of an article, the publisher 14 provides user input to a user interface displaying properties of the article. One of the properties displayed can be a list of potential genres, which can be sent by the articles database 18. The client device can receive user input specifying a change in genre, e.g., the publisher 14 selects a different genre from a dropdown. The client device can submit the change to the volatility analysis engine 22a.

By way of illustration, assume that the system has determined an initial baseline price=$1 for an article classified as opinion, and that an opinion article has a multiplier of 0.9 while a research article has a multiplier of 1.1 applied to the initial baseline price. Other multipliers also are applied to the baseline price, such as for whether the article contains charts or graphs, to how many channels the article will be supplied, for a publisher rating, etc. resulting in an initial valuation of, for example, $20. This initial valuation in turn is used to determine an initial access price, based on factors such as the likely readership, its geographical distribution, local time of day, and many other factors, resulting in an initial access price of Pi,o=$0.15 as an example. This initial access price then changes during the lifetime Ti of the article, as described in the material incorporated by reference, typically in the downward direction along an S-curve. However, an important change of genre during the lifetime of the article may introduce a departure from smoothness in the S-curve. For example, a change from opinion to research genre can result in a recalculation, for example, the application of a multiplier to the access price that exists at the time of the change in genre. If the access price is $0.12 at the time of the genre change, the system can apply a multiplier of 1.16 to that access price and rapidly change the access price to $0.14. Conversely, if the genre classification changes from research to opinion, the multiplier can be 0.83, resulting in a rapid change of the access price from $0.12 to $0.10. The price and multiplier levels in this example are arbitrary, and in actual practice different numbers can and likely would be used. Also, the change in genre is one of many examples, and two of more changes that cause rapid changes in access price can occur at the same time or so close in time that they together cause a rapid change in access price. The two or more events that occur at the same time or close in time may have opposite effects, and the result can be no change in access price or a smaller change than if less than all events had taken place.

The information regarding event that cause departures from smoothness of the S-curve can come from a variety of sources. In the example above, a request from a publisher 14 for a genre change reached volatility analysis engine 22a through system server 16 and articles database 18, although more direct routes are possible. In other examples, volatility analysis engine 22a can cause a departure from S-curve smoothness in response to a system operator's command entered in center server 22, or in response to analysis of new articles added to articles database 18 and comparisons with articles currently being offered for access prices. For example, a report on equipment currently available at sites of gold mining companies in a region of Alaska can suddenly become more valuable upon the appearance in articles database 18 of a report of a major discovery of gold in that region. Through comparison of articles, including keywords, volatility analysis engine 22a can determine the change in value of the existing article and apply a respective multiplier to its current access price to raise it. Conversely, a new article regarding a major discovery of gold in a different region in Alaska, too remote for transfer of mining equipment from the region covered by the currently offered article, can similarly result in a downtick of the S-curve for the currently offered article.

Another example of a sharp down adjustment in access price Pi,t is as follows. Assume that an unknown freelance journalist writes an article and submits it to the system, and that the initial rating of the article is 4.0 and the rating is one of the parameters used in setting the initial value of the article and/or the initial access price for the article. Assume also that during the lifetime of the article the rating decreases from 4.0 to 3.5 on a 5.0 rating scale, for example because of actions of users or because a system administrator has reduced the rating. The access price would decrease in the following manner in one example of price setting: Value of the article prior to the drop in the rating=$1 (Baseline)×0.9 (Genre−Opinion)×$1.00 (no media/charts/graphs)×0.80 (audience score−article appears in 6 channels)×0.80 (Unknown Freelancer)×1.1 O (“4”−Rating of the article at the time of the assessment by the system)=$0.64. The value of the article after the drop in the rating=$1 (base price)×0.9 (Genre−Opinion)×$1.00 (no media/charts/graphs)×0.80 (audience score−article appears in 6 channels)×0.80 (Unknown Freelancer)×1.00 (“3.5”−Rating of the article at the time of the assessment by the system)=$0.58. This new value can be processed as described in the material incorporated by reference to generate access prices.

Yet another example of a sharp decrease in price is as follows. An unknown freelance journalist writes a story at 11:00 am Tuesday NYC time about the rumor of the possible closing of a copper mine in Chile. But soon after the story is made available to users, it turns out there will be no closing. The majority of users give the article a rating of 1 or below. In this case, the value of the article prior to decrease=$1 (Baseline)×0.90 (Genre−Rumor)×1.00 (no media/charts/graphs)×0.80 (audience score−article appears in 6 channels)×0.95 (market signals−one Tier 1 commodity and one Tier 2 company public company are mentioned in the article)×1.15 (based on the repeated use of the word “closing”)×0.80 (Unknown Freelancer)×1.0 (significant nation)×1.30 (time of the day)×5.00 (first breaking news)=$4.09. Value of the article after the rating decrease=$1 (Baseline)×0.90 (Genre−Rumor)×1.00 (no media/charts/graphs)×0.80 (audience score−article appears in 6 channels)×0.95 (market signals−One Tier 1 commodity and one Tier 2 company public company are mentioned in the article)×1.15 (based on the repeated use of the word “closing”)×0.80 (Unknown Freelancer)×1.00 (significant nation)×1.30 (time of the day)×0.20 (article rating is less than 1.5)=$0.16

Another example of a sharp increase in price: The price of the article on the industrial metal, such as copper, may increase dramatically if the number of traders trading copper suddenly increases. The system constantly performs an analysis on the market signals and picks up on the market moving trends, adjusting access price of the appropriate articles accordingly. Thus, the sudden increase in the number of traders of this commodity would increase a multiplier of the baseline price and thus the value and access price, resulting in a sharp uptick in the S-curve.

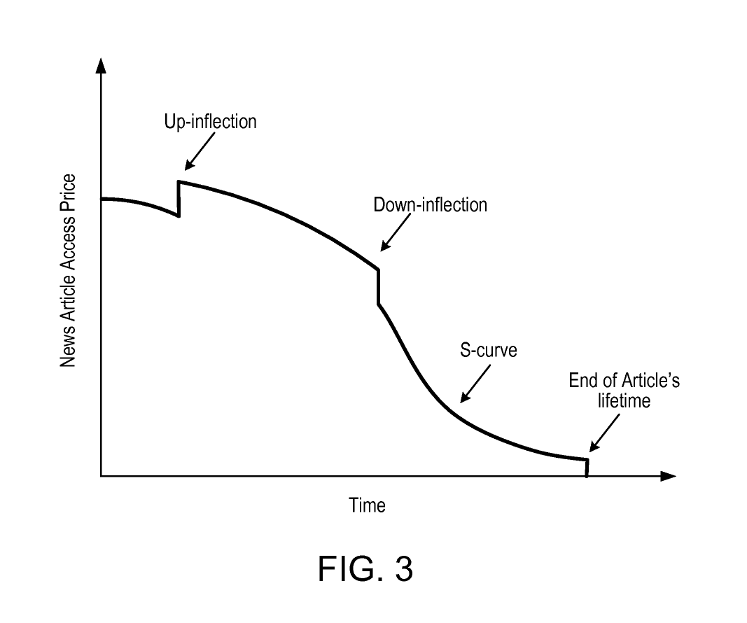

FIG. 3 illustrates an S-curve of access price Pi,t for an article (e.g., the price a pay-per-view user would pay to read or download an article) vs. time during the lifetime Ti of the article. The access price generally decreases with time until the end of the article's lifetime, when it drops to zero or close to zero. However, an abrupt increase in access price can occur in a point of time labeled “up-inflection” as a result of an event such as a genre change from opinion to research or some other change that leads to an abrupt uptick in access price. Conversely, an abrupt decrease in access price can occur at a point in time labeled “down-inflection.” One or more abrupt changes can occur for a given article, in any order of up or down changes, or there can be no abrupt change in the lifetime of a given article.

The above examples of abrupt changes in the current access price and resulting departures from smoothness of the S-curve are only two of many possible examples of using changes in factors that affect or should affect the current access price, and are not meant to limit the scope of the new process described in this patent specification. The abrupt changes in access price can be immediate, i.e., from one price Pi,t to the next-in-time price Pi,t+1, or they can be more gradual so that they are completed over the course of several pricing intervals but still are departures from smoothness of the S-curve.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory program carrier for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program include, by way of example, can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To send for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can send input to the computer. Other kinds of devices can be used to send for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A method for dynamically pricing a plurality of articles using a pricing engine comprising,
receiving, using one or more processors at a system server, a plurality of articles and respective information for each respective article of the plurality of articles, where the respective information for the respective article includes a publisher name, a title, one or more associated genres, and an initial sales price;
repeatedly receiving, at the system server, respective parameters associated with each article, where the respective parameters include at least a history of user access to articles other than the plurality of articles and a history of cumulative revenues for other articles associated with the respective one or more associated genres, where the respective parameters are updated over time;
receiving, for each of the plurality of articles, user input identifying a new genre of the respective article; and
repeatedly determining, for each article, an access price for the respective article over time, where each access price is based on the respective information, the respective parameters, and the new genre.

2. The method of claim 1, where the parameters include at least one or more of the following: a number of users that are currently signed onto the system server, a number of current and potential users of the respective article, a number of users by country or region, a time of day for users on the system server, and a location to which the respective article pertains.

3. The method of claim 1, where the respective information or the respective article further comprises: an article lifetime duration, the article lifetime duration being a duration of time during which the respective article is not free of charge and after which the respective article is free of charge.

4. The method of claim 1, where determining an access price comprises, for a particular article in the one or more plurality of articles:
prior to receiving the user input identifying the new genre of the particular article, selecting the access price according to a first smoothing function; and
in response to receiving the user input, selecting the access price according to a second smoothing function, where the second smoothing function has an inflection different from the first smoothing function.

5. The method of claim 1, further comprising providing each access price for display on a client device.

6. A computer-readable medium having instructions stored thereon, which, when executed by a processor, cause the processor to perform operations comprising:
receiving, using one or more processors at a system server, a plurality of articles and respective information for each respective article of the plurality of articles, where the respective information for the respective article includes a publisher name, a title, one or more associated genres, and an initial sales price;
repeatedly receiving, at the system server, respective parameters associated with each article, where the respective parameters include at least a history of user access to articles other than the plurality of articles and a history of cumulative revenues for other articles associated with the respective one or more associated genres, where the respective parameters are updated over time;
receiving, for each of the plurality of articles, user input identifying a new genre of the respective article; and
repeatedly determining, for each article, an access price for the respective article over time, where each access price is based on the respective information, the respective parameters, and the new genre.
